(19) United States
(12) Patent Application Publication
(10) Pub. No.: US 2005/0275779 A1
(43) Pub. Date: Dec. 15, 2005

(54) Liquid crystal display

(76) Inventor: Yutaka Nanno, Kobe-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/147,331

(22) Filed: Jun. 8, 2005

(30) Foreign Application Priority Data
Jun. 9, 2004 (JP) 2004-171532

(51) Int. Cl. G02F 1/1335

(52) U.S. Cl. 349/117

(57) ABSTRACT

A liquid crystal display includes a liquid crystal cell which includes a back substrate, a front substrate facing the back substrate, and a liquid crystal layer sandwiched between the back substrate and the front substrate, wherein the front substrate is to be located between a viewer and the back substrate, a front polarizer which faces the front substrate, and an outer retardation member which faces the front substrate with the front polarizer interposed therebetween and converts linearly polarized light from the front polarizer into circularly or elliptically polarized light.

### CROSS-REFERENCE TO RELATED APPLICATIONS

This application is based upon and claims the benefit of priority from prior Japanese Patent Application No. 2004-171532, filed Jun. 9, 2004, the entire contents of which are incorporated herein by reference.

### BACKGROUND OF THE INVENTION

1. Field of the Invention

The present invention relates to a liquid crystal display.

2. Description of the Related Art

Many liquid crystal displays use polarizers. Of these liquid crystal displays, a transmissive liquid crystal display has a structure that a liquid crystal cell is sandwiched between a pair of polarizers. On the other hand, a reflective liquid crystal display has a structure that a polarizer is located between a liquid crystal cell and a viewer.

### BRIEF SUMMARY OF THE INVENTION

According to a first aspect of the present invention, there is provided a liquid crystal display comprising a liquid crystal cell which comprises a back substrate, a front substrate facing the back substrate, and a liquid crystal layer sandwiched between the back substrate and the front substrate, wherein the front substrate is to be located between a viewer and the back substrate, a front polarizer which faces the front substrate, and an outer retardation member which faces the front substrate with the front polarizer interposed therebetween and converts linearly polarized light from the front polarizer into circularly or elliptically polarized light.

According to a second aspect of the present invention, there is provided a liquid crystal display comprising a liquid crystal cell which comprises a back substrate, a front substrate facing the back substrate, and a liquid crystal layer sandwiched between the back substrate and the front substrate, wherein the front substrate is to be located between a viewer and the back substrate, a front polarizer which faces the front substrate, and an outer retardation member which faces the front substrate with the front polarizer interposed therebetween and whose retardation is other than a half wavelength, the outer retardation member being arranged such that its slow axis of retardation inclines with respect to transmission axis of the front polarizer.

### BRIEF DESCRIPTION OF THE SEVERAL VIEWS OF THE DRAWING

FIG. 1 is a view schematically showing a liquid crystal display according to a first embodiment of the present invention;

FIG. 2 is a sectional view schematically showing an example of a liquid crystal display panel usable in the liquid crystal display shown in FIG. 1;

FIG. 3 is a view schematically showing a liquid crystal display according to a comparative example; and

FIG. 4 is a sectional view schematically showing a liquid crystal display according to a second embodiment of the present invention.

### DETAILED DESCRIPTION OF THE INVENTION

The embodiments of the present invention will be described below in detail with reference to the accompanying drawing. The same reference numerals denote constituent elements having the same or similar functions throughout the drawing, and repetitive description thereof will be omitted.

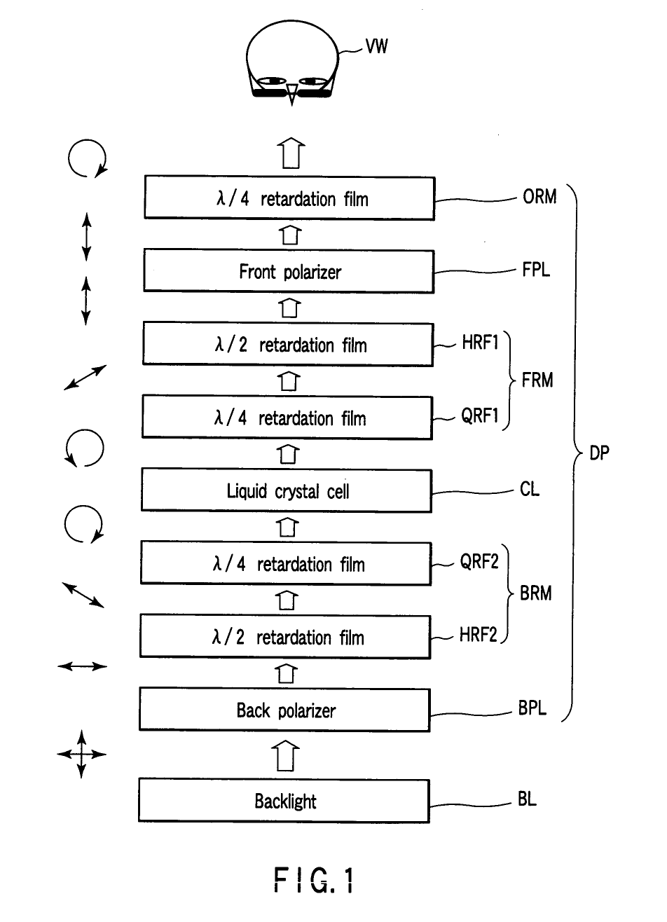

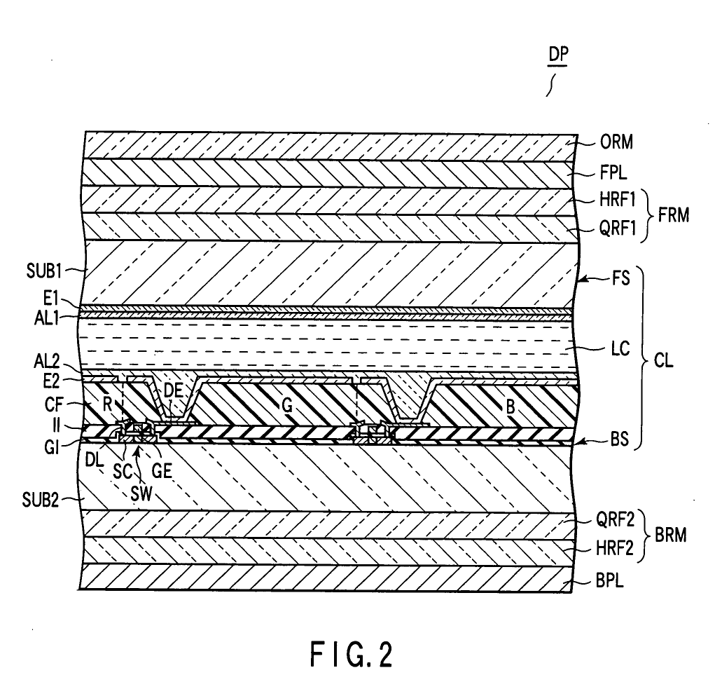

FIG. 1 is a view schematically showing a liquid crystal display according to a first embodiment of the present invention. FIG. 2 is a sectional view schematically showing an example of a liquid crystal display panel usable in the liquid crystal display shown in FIG. 1. Outlined arrows in FIG. 1 indicate the propagation direction of light. Arrows arranged on the left side in FIG. 1 indicate light states corresponding to the outlined arrows.

The liquid crystal display shown in FIG. 1 is a transmissive liquid crystal display. The liquid crystal display includes a liquid crystal display panel DP and backlight BL.

The display panel DP includes a liquid crystal cell CL. A front polarizer FPL is arranged on the front side of the liquid crystal cell CL, i.e., between the liquid crystal cell CL and a viewer VW. A back polarizer BPL is arranged on the rear side of the liquid crystal cell CL, i.e., between the liquid crystal cell CL and the backlight BL.

A front retardation member FRM is located between the liquid crystal cell CL and the front polarizer FPL. In this example, the front retardation member FRM includes a quarter-wave (λ/4) retardation film QRF1 and half-wave (λ/2) retardation film HRF1. The λ/4 retardation film QRF1 and λ/2 retardation film HRF1 are arranged in this order between the liquid crystal cell CL and the front polarizer FPL.

A back retardation member BRM is located between the liquid crystal cell CL and the back polarizer BPL. In this example, the back retardation member BRM includes a λ/4 retardation film QRF2 and λ/2 retardation film HRF2. The λ/4 retardation film QRF2 and λ/2 retardation film HRF2 are arranged in this order between the liquid crystal cell CL and the back polarizer BPL.

The liquid crystal display panel DP also includes an outer retardation member ORM located between the front polarizer FPL and the viewer VW. The outer retardation member ORM converts linearly polarized light from the front polarizer FPL into circularly or elliptically polarized light. In this example, the outer retardation member ORM is a λ/4 retardation film.

The liquid crystal cell CL includes a back substrate BS and front substrate FS. The back substrate BS and front substrate FS face each other. A sealing layer (not shown) is interposed between their peripheries. The space surrounded by the back substrate BS, front substrate FS, and sealing layer is filled with a liquid crystal material. The liquid crystal material forms a liquid crystal layer LC.

The front substrate FS is a counter substrate including a transparent substrate SUB1, front electrode E1, and alignment layer AL1. The front electrode E1 is an optically transparent counter electrode. The front electrode E1 is made of, e.g., indium tin oxide (ITO). An alignment layer treatment process using a rubbing method or photo alignment method is executed for the alignment layer AL1, as needed.

The back substrate BS is an array substrate including a transparent substrate SUB2, scanning lines, signal lines DL, pixel circuits, and alignment layer AL2. Each pixel circuit includes a switching element SW and back electrode E2.

Semiconductor layers SC such as polysilicon layers are arrayed on the transparent substrate SUB2 in correspondence with the pixel circuits. The semiconductor layers SC are covered with a gate insulator GI. The scanning lines are arrayed on the gate insulator GI in correspondence with the rows of pixel circuits. Gates GE corresponding to a row of pixel circuits are connected to a scanning line. The gates GE cross the semiconductor layers SC, respectively. The semiconductor layer SC, gate insulator GI, and gate GE form a thin-film transistor serving as a switching element.

The scanning lines, gates GE, and gate insulator GI are covered with an interlayer insulating film II. The signal lines DL are arrayed on the interlayer insulating film II in correspondence with the columns of pixel circuits. In addition, drain electrodes DE are arrayed in correspondence with the pixel circuits. Sources and drains formed in the semiconductor layers SC are connected to the signal lines DL and drain electrodes DE via through holes formed in the interlayer insulating film II.

A color filter CF is formed on the signal lines DL, drain electrodes DE, and interlayer insulating film II. The color filter CF includes a red colored layer R, green colored layer G, and blue colored layer B. Each of the colored layers R, G, and B has a shape corresponding to a column of pixel circuits. These layers form a stripe pattern.

The back electrodes E2 are arrayed on the color filter CF in correspondence with the pixel circuits. The back electrode E2 is an optically transparent pixel electrode which is connected to the drain electrode DE via a through hole formed in the color filter CF. The back electrode E2 is made of, e.g., ITO.

The back electrodes E2 are covered with the alignment layer AL2. An alignment layer treatment process using a rubbing method or photo alignment method is executed for the alignment layer AL2, as needed.

The sealing layer (not shown) surrounds a display region defined by the array of pixel circuits. The sealing layer can be formed by using an adhesive.

A liquid crystal material suitably selected in accordance with the display mode of the display panel DP is used for the liquid crystal layer LC. For example, for a twisted nematic (TN) mode, supertwisted nematic (STN) mode, or optically compensated birefringence (OCB) mode, a liquid crystal material having positive dielectric anisotropy is used. For a vertically aligned (VA) mode, a liquid crystal material having negative dielectric anisotropy is used. In the latter case, the alignment layer treatment process for the alignment layers AL1 and AL2 need not be executed.

In the VA mode, the display panel DP can employ, e.g., the following structure.

The polarizers BPL and FPL are arranged such that their transmission axes cross perpendicularly. The λ/2 retardation film HRF2 is arranged such that its slow axis of retardation crosses the transmission axis of the back polarizer BPL at an angle of +15°. The λ/4 retardation film QRF2 is arranged such that its slow axis of retardation crosses the transmission axis of the back polarizer BPL at an angle of +75°. The λ/4 retardation film QRF1 is arranged such that its slow axis of retardation crosses the slow axis of retardation of the λ/4 retardation film QRF2 perpendicularly. The λ/2 retardation film HRF2 is arranged such that its slow axis of retardation crosses the slow axis of retardation of the λ/4 retardation film QRF1 at an angle of −60°. The front polarizer FPL is arranged such that its transmission axis crosses the slow axis of retardation of the λ/2 retardation film HRF2 at an angle of −15°.

The outer retardation member ORM is arranged such that its slow axis of retardation inclines with respect to the transmission axis of the front polarizer FPL. When the outer retardation member ORM is a λ/4 retardation film, it is arranged typically such that its slow axis of retardation crosses the transmission axis of the front polarizer FPL at an angle of +45° or −45°. In this example, the outer retardation member ORM is a λ/4 retardation film, and its slow axis of retardation crosses the transmission axis of the front polarizer FPL at an angle of +45°.

In this liquid crystal display, an image is displayed by the following method.

The backlight BL radiates natural light. The back polarizer BPL passes, of the light from the backlight BL, only a linearly polarized light component having a plane of polarization parallel to the transmission axis of the back polarizer BPL. The λ/2 retardation film HRF2 rotates the plane of polarization of the linearly polarized light by +30°. The λ/4 retardation film QRF2 converts the linearly polarized light into right-handed circularly polarized light.

In the VA mode, when the voltage between the electrodes E1 and E2 is lower than the threshold voltage, i.e., in the OFF state, the retardation of the liquid crystal cell CL is almost zero. Hence, in the OFF state, the right-handed circularly polarized light enters the λ/4 retardation film QRF1.

The λ/4 retardation film QRF1 converts the right-handed circularly polarized light into linearly polarized light whose plane of polarization crosses the transmission axis of the back polarizer BPL at an angle of +30°. The λ/2 retardation film HRF1 rotates the plane of polarization of the linearly polarized light by −30°. As a result, the linearly polarized light having a plane of polarization perpendicular to the transmission axis of the front polarizer FPL enters the front polarizer FPL. Hence, in the OFF state, the light from the backlight BL does not reach the viewer VW. That is, dark display is done in the OFF state.

When the voltage between the electrodes E1 and E2 is higher than the threshold voltage, i.e., in the ON state, the retardation of the liquid crystal cell CL is larger than zero. Hence, in the ON state, elliptically polarized light or left-handed circularly polarized light enters the λ/4 retardation film QRF1.

The λ/4 retardation film QRF1 converts the left-handed circularly polarized light into linearly polarized light whose plane of polarization crosses the transmission axis of the back polarizer BPL at an angle of −60°. Hence, in the ON state, the λ/4 retardation film QRF1 passes at least part of the light from the liquid crystal cell CL.

The λ/2 retardation film HRF1 rotates the plane of polarization of the linearly polarized light by −30°. As a result, in the ON state, the linearly polarized light having a plane of polarization parallel to the transmission axis of the front polarizer FPL enters the front polarizer FPL. The front polarizer FPL passes the linearly polarized light. The outer retardation member ORM converts the linearly polarized light into right-handed circularly polarized light. Hence, in the ON state, part of the light from the backlight BL reaches the viewer VW. That is, bright display is done in the ON state.

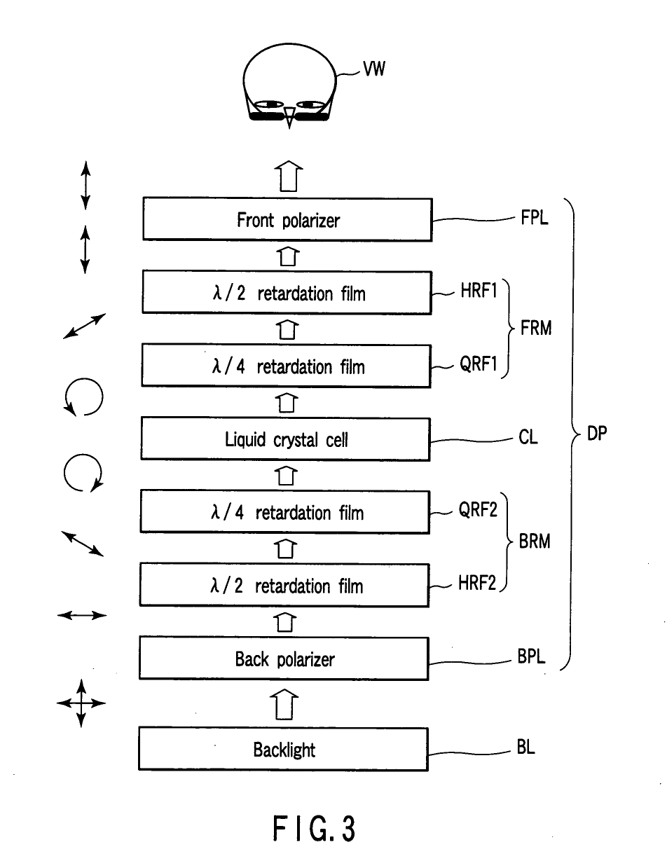

FIG. 3 is a view schematically showing a liquid crystal display according to a comparative example. This liquid crystal display has the same structure as the liquid crystal display shown in FIG. 1 except that it includes no outer retardation member ORM.

In this liquid crystal display, an image is displayed by almost the same method as in the liquid crystal display shown in FIG. 1. However, since the liquid crystal display shown in FIG. 3 includes no outer retardation member ORM, light which reaches the viewer VW in the ON state is linearly polarized light.

A liquid crystal display is used in various devices such as a cellular phone, portable data terminal, digital camera, and an instrument system mounted in an automotive vehicle. These devices are used in a variety of environments. Hence, the viewer VW often wears eyeware such as sunglasses.

Some eyeware has a polarizing function like sunglasses using polarizing lenses. Light radiated from the liquid crystal display shown in FIG. 3 is linearly polarized light. When the viewer VW wears such eyeware, the brightness of an image changes in accordance with the angle between the plane of polarization of linearly polarized light from the liquid crystal display and the transmission axis of the eyeware. For example, when the plane of polarization of linearly polarized light from the liquid crystal display crosses the transmission axis of the eyeware, the image looks darker as compared to a case wherein they are parallel. When the plane of polarization of linearly polarized light from the liquid crystal display and the transmission axis of the eyeware cross perpendicularly, the image can be totally invisible.

As described above, light radiated from the liquid crystal display shown in FIG. 1 is circularly polarized light. Hence, the brightness of an image does not change, and the image is prevented from becoming totally invisible.

The second embodiment of the present invention will be described next.

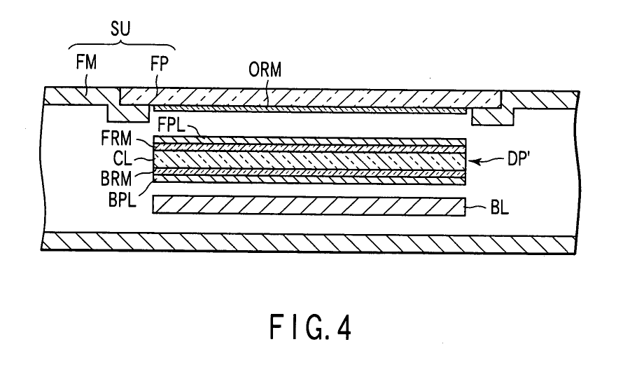

FIG. 4 is a sectional view schematically showing a liquid crystal display according to the second embodiment of the present invention. This liquid crystal display can be used as, e.g., the display unit of a cellular phone.

The liquid crystal display shown in FIG. 4 includes a support unit SU, display panel DP′, outer retardation member ORM, and backlight BL.

The support unit SU includes a frame member FM and transparent face plate FP. In this example, the support unit SU forms a casing which surrounds the display panel DP′ and backlight BL.

An opening is provided in the front plate of the frame member FM. The transparent face plate FP is fitted in the opening. The backlight BL is located between the back plate of the frame member FM and the transparent face plate FP. The display panel DP′ is located between the backlight BL and the transparent face plate FP. The display panel DP′ and backlight BL are supported by the frame member FM.

The transparent face plate FP is a transparent protective plate made of, e.g., acrylic. The outer retardation member ORM is bonded to the outer or inner surface of the transparent face plate FP. In this example, the outer retardation member ORM is bonded to the surface of the transparent face plate FP facing the display panel DP′.

The display panel DP′ has the same structure as the display panel DP described in the first embodiment except that the display panel DP′ includes no outer retardation member ORM. The display panel DP′ is arranged such that a front polarizer FPL faces the outer retardation member ORM.

Even in this embodiment, the outer retardation member ORM is arranged such that its slow axis of retardation crosses the transmission axis of the front polarizer FPL at an angle of +45° or −45°, as in the first embodiment. Hence, even in the second embodiment, the same effect as described in the first embodiment is obtained.

The liquid crystal displays of the first and second embodiments can be mounted in various devices such as a cellular phone, portable data terminal, digital camera, and instrument system.

In the first and second embodiments, linearly polarized light is converted into circularly polarized light by the outer retardation member ORM. The outer retardation member ORM may convert linearly polarized light into elliptically polarized light. For example, the outer retardation member ORM may be arranged such that its slow axis of retardation inclines with respect to the transmission axis of the front polarizer FPL. Alternatively, a retardation film having any retardation except quarter- or half-wave may be used as the outer retardation member ORM. When the outer retardation member ORM converts linearly polarized light into elliptically polarized light, an image is prevented from becoming totally invisible even when eyeware having a polarizing function is used. When the outer retardation member ORM converts linearly polarized light into elliptically polarized light close to circularly polarized light, the brightness of an image rarely changes even when the angle between the plane of polarization of the linearly polarized light and the transmission axis of the eyeware changes.

The λ/2 retardation films HRF1 and HRF2 may be omitted from the liquid crystal displays of the first and second embodiments. Alternatively, the retardation members FRM and BRM may be omitted from the liquid crystal displays of the first and second embodiments.

In the first and second embodiments, the present invention is applied to a transmissive liquid crystal display. The present invention can also be applied to a reflective liquid crystal display. For example, the backlight BL, back polarizer BPL, and back retardation member BRM may be omitted from the liquid crystal displays of the first and second embodiments, and a reflecting electrode may be used as the back electrode E2.

Alternatively, the present invention may be applied to a semi-transmissive liquid crystal display. For example, in the liquid crystal displays of the first and second embodiments, each back electrode E2 may be partially optically reflective.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A liquid crystal display comprising:
a liquid crystal cell which comprises a back substrate, a front substrate facing the back substrate, and a liquid crystal layer sandwiched between the back substrate and the front substrate, wherein the front substrate is to be located between a viewer and the back substrate;
a front polarizer which faces the front substrate; and
an outer retardation member which faces the front substrate with the front polarizer interposed therebetween and converts linearly polarized light from the front polarizer into circularly or elliptically polarized light.

2. The display according to claim 1, further comprising a front retardation member which is interposed between the front substrate and the front polarizer.

3. The display according to claim 1, further comprising a back polarizer which faces the back substrate.

4. The display according to claim 3, further comprising:
a front retardation member which is interposed between the front substrate and the front polarizer; and
a back retardation member which is interposed between the back substrate and the back polarizer.

5. The display according to claim 1, wherein the outer retardation member is a λ/4 retardation member.

6. The display according to claim 1, wherein the outer retardation member converts linearly polarized light from the front polarizer into circularly polarized light.

7. The display according to claim 1, wherein the front polarizer is attached to the liquid crystal cell, and the outer retardation member is attached to the front polarizer.

8. The display according to claim 1, further comprising a support unit which supports the liquid crystal cell and the outer retardation member.

9. The display according to claim 8, wherein the support unit includes a frame member which supports the liquid crystal cell, and a transparent face plate on which the outer retardation member is attached.

10. A liquid crystal display comprising:
a liquid crystal cell which comprises a back substrate, a front substrate facing the back substrate, and a liquid crystal layer sandwiched between the back substrate and the front substrate, wherein the front substrate is to be located between a viewer and the back substrate;
a front polarizer which faces the front substrate; and
an outer retardation member which faces the front substrate with the front polarizer interposed therebetween and whose retardation is other than a half wavelength, the outer retardation member being arranged such that its slow axis of retardation inclines with respect to transmission axis of the front polarizer.

11. The display according to claim 10, further comprising a front retardation member which is interposed between the front substrate and the front polarizer.

12. The display according to claim 10, further comprising a back polarizer which faces the back substrate.

13. The display according to claim 12, further comprising:
a front retardation member which is interposed between the front substrate and the front polarizer; and
a back retardation member which is interposed between the back substrate and the back polarizer.

14. The display according to claim 10, wherein the outer retardation member is a λ/4 retardation member.

15. The display according to claim 14, wherein the outer retardation member is arranged such that its slow axis of retardation crosses the transmission axis of the front polarizer at an angle of −45° or +45°.

16. The display according to claim 10, wherein the front polarizer is attached to the liquid crystal cell, and the outer retardation member is attached to the front polarizer.

17. The display according to claim 10, further comprising a support unit which supports the liquid crystal cell and the outer retardation member.

18. The display according to claim 17, wherein the support unit includes a frame member which supports the liquid crystal cell, and a transparent face plate on which the outer retardation member is attached.
